(19) United States
(12) Patent Application Publication
(10) Pub. No.: US 2015/0138780 A1
(43) Pub. Date: May 21, 2015

(54) ILLUMINATION DEVICE

(71) Applicant: Mitsubishi Chemical Corporation, Chiyoda-ku (JP)

(72) Inventors: Kouta YOSHIZAWA, Tokyo (JP); Toshihiko KURIYAMA, Kanagawa (JP); Akeo KASAKURA, Tokyo (JP); Yuki KOHARA, Tokyo (JP); Toru TAKEDA, Tokyo (JP)

(73) Assignee: Mitsubishi Chemical Corporation, Chiyoda-ku (JP)

(21) Appl. No.: 14/606,108

(22) Filed: Jan. 27, 2015

Related U.S. Application Data
(63) Continuation of application No. PCT/JP2013/069166, filed on Jul. 12, 2013.

(30) Foreign Application Priority Data
Jul. 31, 2012 (JP) 2012-169891

(51) Int. Cl. F21V 29/83; F21V 5/04; F21V 29/60

(52) U.S. Cl. CPC F21V 29/83; F21V 29/60; F21V 5/04
USPC 362/326; 362/373

(57) ABSTRACT

The illumination device includes: a case; a heat sink which has a bottom part in which an LED module is installed, a cylindrical wall part standing upright from the bottom part and disposed such that a clearance is created between the cylindrical wall part and an inner wall surface of the case, and an open end formed at the front end of the cylindrical wall part; a fan which is housed in the case; an air intake passage which guides to the fan, air introduced from the lateral side of the case into the case; and an air discharge passage which is formed along the outer surface of the bottom part and the outer wall surface of the cylindrical wall part in the heat sink and discharges the air sent from the fan from the front end side of the heat sink to the outside.

### CROSS-REFERENCE TO RELATED APPLICATION

This application is a continuation application of International Application PCT/JP2013/069166 filed on Jul. 12, 2013 and designated the U.S., (and claims priority from Japanese Patent Application 2012-169891 which was filed on Jul. 31, 2012,) the entire contents of which are incorporated herein by reference.

### TECHNICAL FIELD

The present invention relates to an illumination device.

### BACKGROUND ART

Various illumination devices have been developed which use a high-efficiency and long-life LED (Light-emitting Diode) instead of a common lamp fitting such as a halogen lamp. As such an illumination device, for example, a device having an LED module, constituted of a package of an LED mounted on a substrate, fitted in a metal heat sink and a base fitted in this heat sink through a case (enclosure) is widely used in practical applications. When the temperature of the LED becomes high due to the heat generated from the LED, the luminous efficiency of the LED degrades, resulting in problems such as a decrease in the light output of the illumination device or shortening of the service life of the LED. In addition, since the lens constituting the illumination device is in most cases made of resin, the lens may be damaged due to heat generation of the LED. It is therefore required in this type of illumination device to efficiently dissipate the heat generated from the LED.

For common lamp fittings such as halogen lamps, standards (e.g., 07527-JIS-6320-2) specifying the maximum outer diameter, the total length, etc. are in place. Accordingly, when a halogen lamp is to be replaced by an LED illumination device, the maximum outer diameter, the total length, etc. of the illumination device are required to conform to the existing standards, which makes it difficult in reality to provide a large heat sink. Meanwhile, in recent years, an illumination device having a so-called active cooling function in which a fan for cooling an LED is installed inside the case to forcibly cool the LED has been proposed.

Patent Document 1: Japanese Patent No. 4757480

Patent Document 2: Japanese National Publication of International Patent Application No. 2010-541152

Patent document 3: Japanese National Publication of International Patent Application No. 2012-509571

Patent document 4: Japanese Patent Laid-Open No. 2010-86713

Patent document 5: Japanese Patent Laid-Open No. 2011-165351

Patent document 6: Japanese Patent No. 4913259

### SUMMARY OF INVENTION

### Technical Problem

On the other hand, a one-core (single) LED module having an LED concentrated in the central part of the substrate has been recently used as an LED module in practical applications. The one-core LED module has advantages in that light distribution of the illumination device is easy to control and that so-called multi-shadow (multiple shadow) is less likely to occur. However, performing active cooling of the LED while conforming the maximum outer diameter, the total length, etc. of the illumination device to the existing standards often involves the following inconveniences.

For instance, in many of the conventional illumination devices which perform active cooling, an air intake port and an air discharge port are disposed close to each other, and in this case, the warm air having been discharged from the air discharge port is suctioned again from the air intake port, which causes degradation of the LED cooling efficiency. When priority is given to the layout design of the air intake passage or the air discharge passage in order to avoid such double suction of the air, the freedom in mounting the LED on the substrate of the LED module is narrowed, and this has a negative effect in that the above-mentioned one-core LED module cannot be applied. Moreover, the basic performance required for an illumination device adopting this type of active cooling includes high LED cooling efficiency.

The present invention is to solve the above-described problems, and has an object of providing an illumination device which can improve the luminous efficiency.

### Solution to Problem

In order to solve the above-described problems, an illumination device according to the present invention includes: a case having an open face on the front end side; a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case; a fan which is housed in the case so as to face the outer surface of the bottom part in the heat sink and serves to cool the LED; an air intake passage which guides to the fan the air introduced from the lateral side of the case into the case; and an air discharge passage which is formed along the outer surface of the bottom part and the outer wall surface of the cylindrical wall part in the heat sink and discharges the air sent from the fan from the front end side of the heat sink to the outside.

According to the illumination device related to the above-described configuration, the outside air is introduced from the lateral side of the case main body, and the air warmed while cooling the LED is discharged from the front end side of the heat sink to the outside. In this way, the double suction of the warmed air having been once discharged from the illumination device being suctioned again can be avoided. In addition, since the air discharge passage is formed along the outer wall surface of the cylindrical wall part in the heat sink, the freedom can be sufficiently secured in the aspect in which the LED module is installed in the bottom part of the heat sink. That is, since the entire surface of the bottom part of the heat sink is available as the installation space of the LED module, it is possible, for example, to constitute a one-core type by disposing the LED module in the central part of the bottom part. Moreover, the air flowing through the air discharge passage removes the heat of the heat sink also while flowing along the outer wall surface of the cylindrical wall part in the heat sink. Thus, a sufficient chance can be secured for the cooling air flowing through the air discharge passage to come into contact with the heat sink, so that heat dissipation from the heat sink can be further promoted.

A through-hole penetrating the bottom part may be formed in the bottom part of the heat sink. According to this configuration, part of the air which is blown from the fan against the outer surface of the bottom part of the heat sink can be supplied through the through-hole to the side of the space where the LED module is housed. That is, it is possible to guide additionally part of the cooling air to the surface of the LED module and directly cool the LED with this air. Therefore, cooling of the LED is promoted and the cooling efficiency can be further enhanced.

When the through-hole is provided in the bottom part of the heat sink as described above, the illumination device may further include a lens, which is fitted in the heat sink and has a lateral surface disposed so as to face the inner wall surface of the cylindrical wall part such that a ventilation path is formed between the lateral surface and the inner wall surface. In this case, part of the air sent from the fan toward the outer surface of the bottom part in the heat sink may be discharged to the outside through the through-hole and the ventilation path. The illumination device thus configured can discharge the air sent from the fan via the through-hole to the outside of the illumination device through the ventilation path. Then, this ventilation path is discharged to the outside from the open end provided on the front end side of the heat sink. It is therefore possible to prevent the warm air having been released to the outside through the ventilation path from being taken into the illumination device again. It is also possible to control an optical characteristic such as an angle of light distribution.

The inner wall surface of the cylindrical wall part may be formed as a reflector which reflects the light generated by the LED. The illumination device thus configured can control an optical characteristic such as an angle of light distribution. The extraction efficiency of the light generated by the LED can also be improved.

Here, in a first configuration example related to the illumination device, the illumination device may further include a second heat sink provided between the case and the heat sink, wherein: the second heat sink may have a division wall which divides the inside of the case, such that a clearance is provided between the second heat sink and the cylindrical wall part as well as between the second heat sink and the inner wall surface of the case, while covering the cylindrical wall part of the heat sink, and a protruding edge part which is formed by the front open end side of the division wall protruding further to the front side than the open face of the case; a rear open end of the division wall may be disposed so as to face an air outlet of the fan; the outside air is introduced from the clearance created between the protruding edge part of the second heat sink and the front end edge part of the case, and the introduced air is guided to the fan through the clearance between the inner wall surface of the case and the outer wall surface of the division wall; and the air from the fan is discharged to the outside through the clearance between the outer wall surface of the cylindrical wall part of the heat sink and the inner wall surface of the division wall.

In the illumination device according to the first configuration example, the heat sink may further have: a second protruding edge part which is formed by the open end side of the cylindrical wall part protruding further to the front side than the open face of the case and which is disposed so as to face the protruding edge part of the second heat sink; and multiple protruding parts which protrude from the outer surface of the second protruding edge part so as to abut on the protruding edge part of the second heat sink and which leave part of the clearance between the protruding edge part of the second heat sink and the second protruding edge part as an air discharge port while covering the rest of the clearance. Moreover, of adjacent ones of the protruding parts, a pair of opposite wall surfaces which extends from the second protruding edge part of the heat sink toward the protruding edge part of the second heat sink and forms one of the air discharge ports may be inclined in the same direction. In this case, the pair of opposite wall surfaces may be inclined in the circumferential direction of the second protruding edge part.

As described above, the structure of the air discharge port in the heat sink with the passage twisted in the circumferential direction of the cylindrical wall part (second protruding edge part) has advantages in that the air is more smoothly discharged from the air discharge port, and that the flow rate of the air discharged from the air discharge port can be increased. As a result, the supply amount of the cooling air supplied from the fan to the heat sink increases, so that the LED cooling efficiency can be enhanced.

In the illumination device according to the first configuration example, the air outlet of the fan may be coupled with the rear open end of the division wall in the second heat sink. The illumination device thus configured can prevent collision between the air flowing through the air intake passage and the air sent out from the fan toward the bottom part of the heat sink. Therefore, the air from the fan can be efficiently guided to the heat sink and the LED cooling efficiency can be improved.

In a second configuration example related to the illumination device, the heat sink may have: a collar part which is formed on the open end side in the cylindrical wall part and protrudes further to the lateral side than the other portions; and an air discharge port which penetrates the collar part, wherein an intake port which communicates with the air intake passage may be formed at a position of the outer wall surface of the case on the rear side of the position where the air outlet of the fan housed in the case is disposed. Also in such a second configuration example, advantages similar to those of the first configuration example can be provided. In addition, in the second configuration example, the manufacturing cost of the illumination device can be further reduced since the second heat sink is not essential for the configuration.

The air discharge port may be defined by a pair of wall surfaces along the radial direction of the collar part and a pair of wall surfaces along the circumferential direction of the collar part, and the pair of wall surfaces along the radial direction of the collar part may be inclined in the same direction. In this case, the pair of wall surfaces along the radial direction of the collar part may be inclined in the circumferential direction of the collar part. Thus, the structure of the air discharge port in the heat sink with the passage twisted in the circumferential direction of the cylindrical wall part (collar part) has advantages in that the air is more smoothly discharged from the air discharge port, and that the flow rate of the air discharged from the air discharge port can be increased. As a result, the amount of the cooling air supplied from the fan to the heat sink increases, so that the LED cooling efficiency can be enhanced.

The illumination device according to the present invention may include: a case which has an open face on the front end side; a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case; a fan which is housed in the case so as to face the outer surface of the bottom part in the heat sink and serves to cool the LED; a first ventilation path which communicates between the outside of the case on the lateral side and the fan; and a second ventilation path which if formed along the outer surface of the bottom part and the outer wall surface of the cylindrical wall part in the heat sink and which communicates between the fan and the front end-side outside of the heat sink, wherein the fan is disposed between the first ventilation path and the second ventilation path. In this case, the power source substrate may be disposed so as to be located on the rear end side of the illumination device and be cooled by the air passing through the first ventilation path.

An illumination device according to the present invention includes: a case having an open face on the front end side; a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case; a fan which is housed in the case so as to face the outer surface of the bottom part in the heat sink and serves to cool the LED; an air intake passage which is formed along the outer wall surface of the cylindrical wall part and the outer surface of the bottom part in the heat sink and guides the air introduced from the front end side of the heat sink to the fan; and an air discharge passage which discharges the air sent from the fan from the lateral side of the case to the outside.

The means for solving the problems in the present invention can be used in combination as far as possible.

### Advantageous Effects of Invention

According to the present invention, in an illumination device which performs active cooling of an LED using a fan, the freedom is secured in the aspect in which an LED module is installed, and moreover, it is possible to enhance the cooling efficiency while preventing the warm air having been once discharged from being suctioned again. Thus, an illumination device which can improve the luminous efficiency can be realized.

### BRIEF DESCRIPTION OF DRAWINGS

FIG. 1 is an outline perspective view of an illumination device according to Embodiment 1.

FIG. 2 is an exploded perspective view of the illumination device according to Embodiment 1.

FIG. 3 is a cross-sectional view of the illumination device according to Embodiment 1.

FIG. 4 is an outline perspective view of a heat sink according to Embodiment 1.

FIG. 5 is a transparent view of the heat sink according to Embodiment 1.

FIG. 6 is a front view of the heat sink according to Embodiment 1.

FIG. 7 is a rear view of the heat sink according to Embodiment 1.

FIG. 8 is a cross-sectional view of the heat sink according to Embodiment 1.

FIG. 9 is a side view of the heat sink according to Embodiment 1.

FIG. 10 is a view illustrating an air flow in the illumination device according to Embodiment 1.

FIG. 11 is a cross-sectional view of a heat sink according to a modified example of Embodiment 1.

FIG. 12 is a view illustrating the structure of an air discharge port according to the modified example of Embodiment 1.

FIG. 13 is an outline perspective view of an illumination device according to Embodiment 2.

FIG. 14 is an exploded perspective view of the illumination device according to Embodiment 2.

FIG. 15 is a cross-sectional view along the line B-B of FIG. 13.

FIG. 16 is a view illustrating a modified example of a heat sink according to Embodiment 2.

FIG. 17 is a cross-sectional view of an illumination device according to Embodiment 3.

FIG. 18 is a cross-sectional view of an illumination device according to Embodiment 4.

FIG. 19 is a block diagram depicting a configuration for controlling rotation of the fan.

### DESCRIPTION OF EMBODIMENTS

In the following, embodiments for implementing the present invention will be described in detail as examples with reference to the drawings. It is intended that, unless otherwise described, the technical scope of the present invention is not limited to the dimensions, material, and shape of the components and their relative arrangement, etc. described in these embodiments.

### Embodiment 1

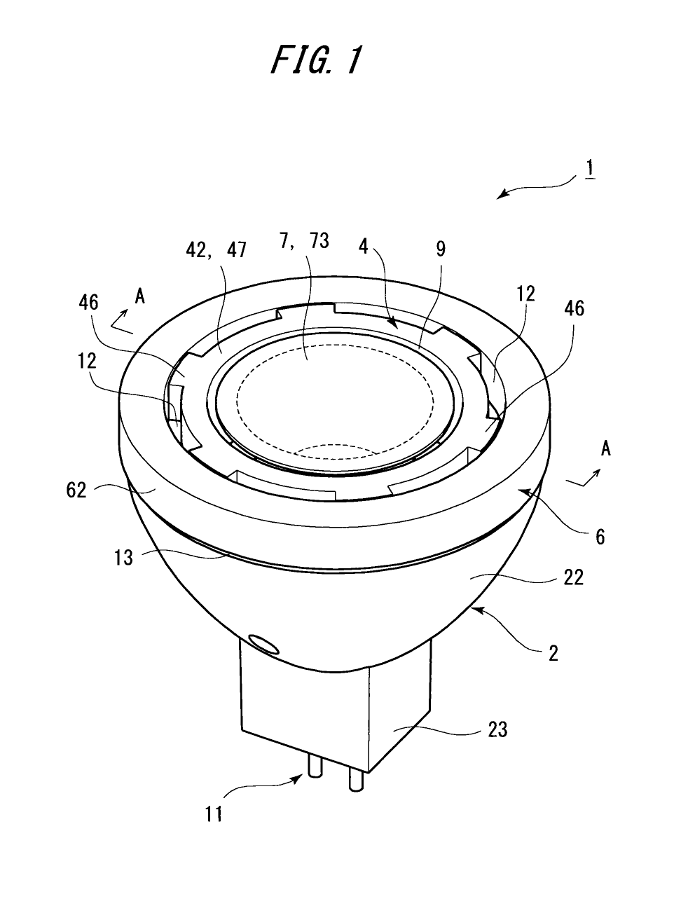

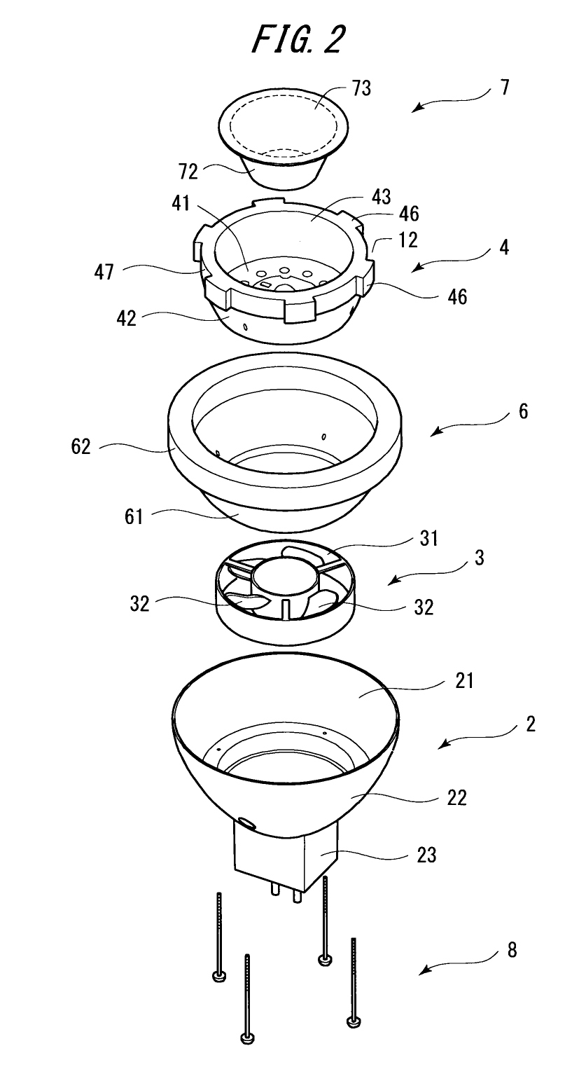

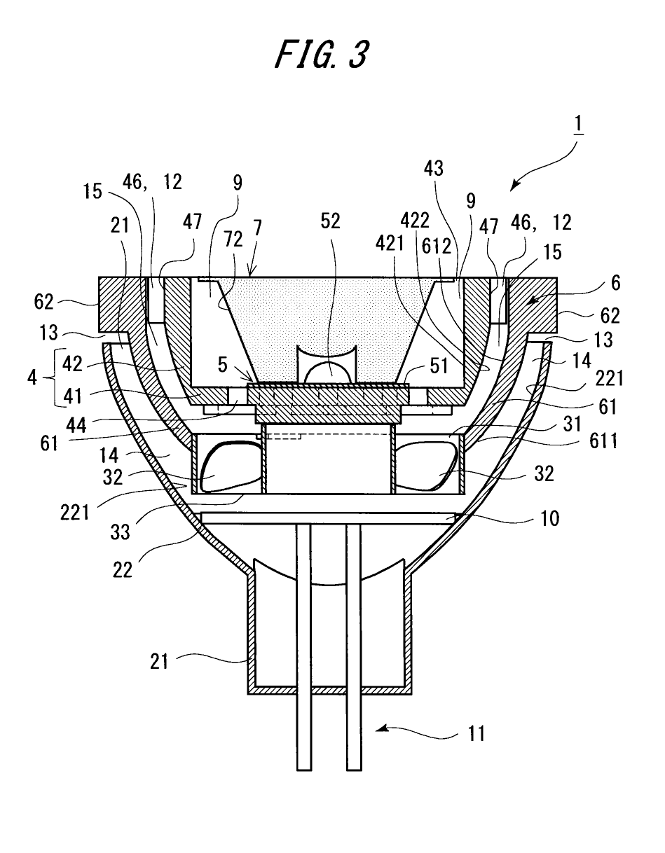

FIG. 1 is an outline perspective view of an illumination device 1 according to Embodiment 1. FIG. 2 is an exploded perspective view of the illumination device 1 according to Embodiment 1. FIG. 3 is a cross-sectional view of the illumination device 1 according to Embodiment 1. FIG. 3 is a cross-sectional view along the line A-A of FIG. 1. The illumination device 1 includes a case 2, a fan 3, a heat sink 4, an LED module 5, a second heat sink 6, a lens 7, a fixing member 8, etc. In this description, the side on which the lens 7 for outputting the light emitted from the LED to the outside is provided is defined as the “front side” of the illumination device 1, while the opposite side is defined as the “rear side”. In this embodiment, the description will be based on an example where the illumination device 1 is, for example, an MR16-type LED illumination device which can be replaced with an MR16-type halogen lamp having an outer diameter of approximately 50 mm.

The case 2 is an enclosure which includes a case main body part 22 with an open face 21 formed on the front end side, and a substantially rectangular parallelepiped base part 23 which is provided on the rear end side of the case main body 22. The case 2 may be formed of a member, such as aluminum, having a good heat dissipation property. The case main body 22 has a bowl shape which gradually increases in diameter from the base part 23 toward the open face 21. However, the shape of the case 2 is not limited to the above-mentioned example, and various shapes can be adopted.

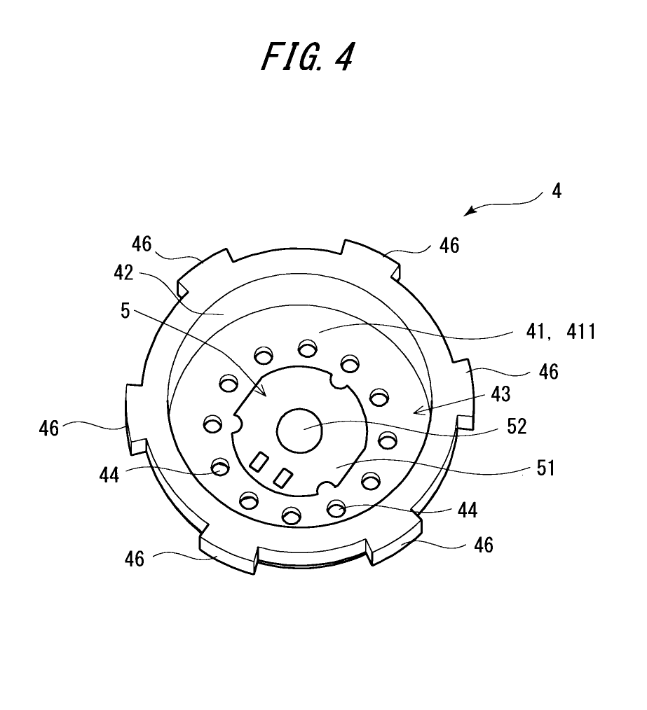

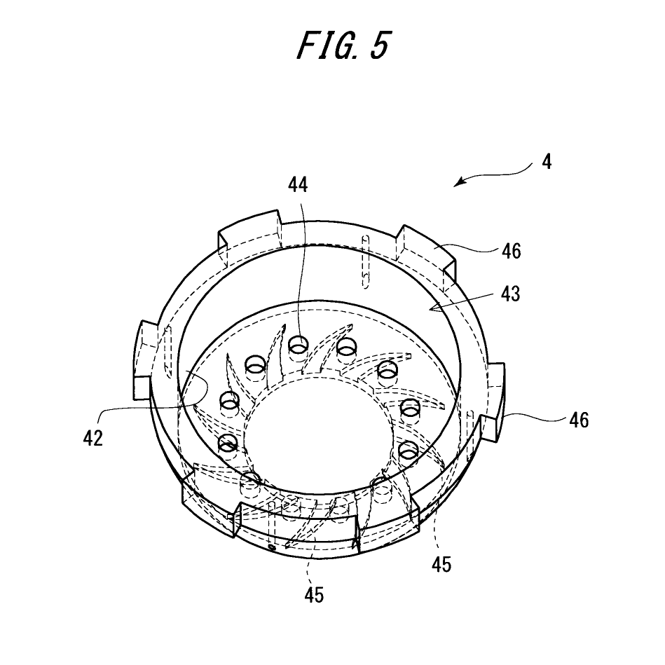

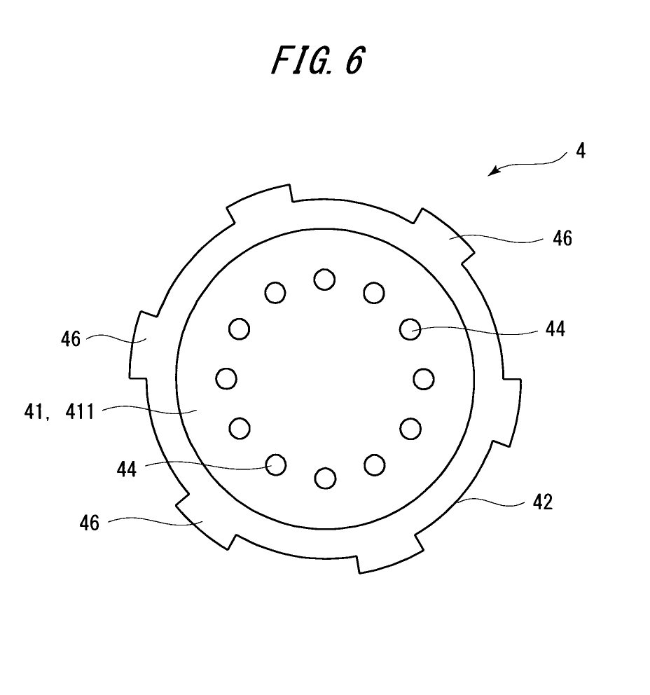

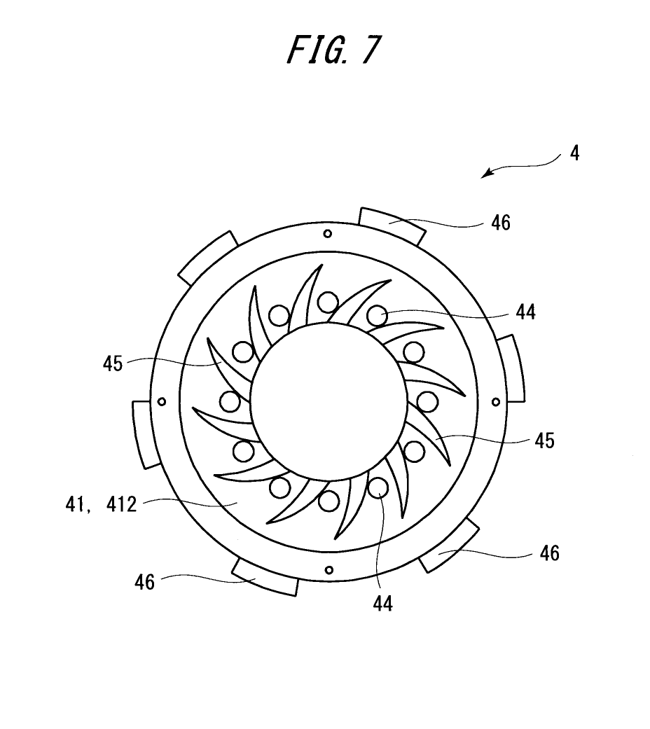

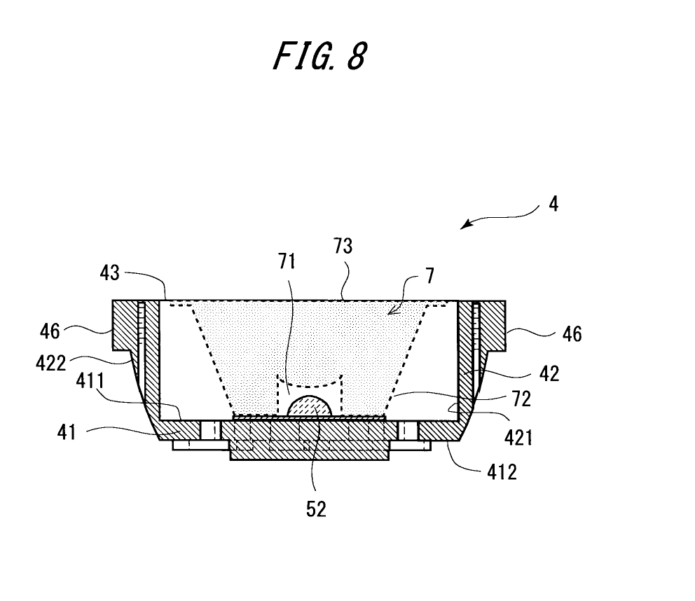

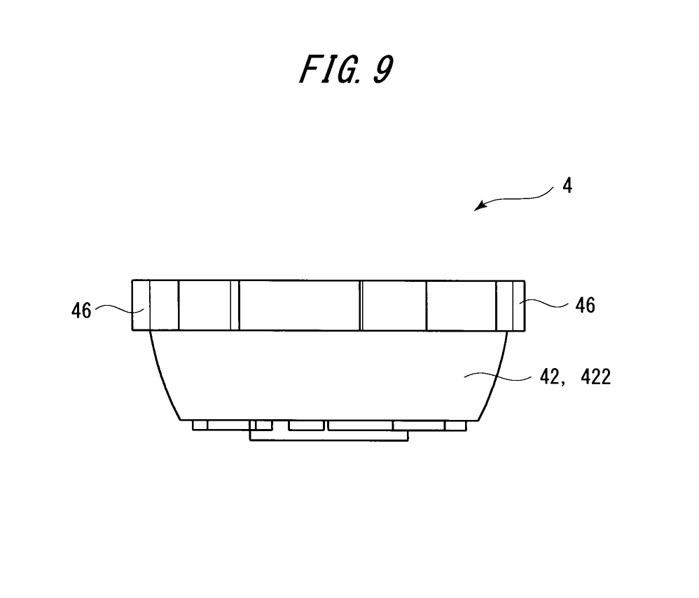

The heat sink 4 has a cylindrical closed-end shape (which can also be called a bowl shape), and, for example, is formed of a metal material, such as aluminum, having a good heat dissipation property. FIGS. 4 to 9 are views illustrating the detailed configuration of the heat sink 4. FIG. 4 is an outline perspective view of the heat sink 4 and depicts a state of the heat sink 4 viewed obliquely from the front side. FIG. 5 is a transparent view of the heat sink 4. FIG. 6 is a front view of the heat sink 4. FIG. 7 is a rear view of the heat sink 4. FIG. 8 is a cross-sectional view of the heat sink 4. FIG. 9 is a side view of the heat sink 4. The heat sink 4 will be described with reference to FIG. 1 to FIG. 9.

The heat sink 4 has a bottom part 41 in which the LED module 5 is installed (placed), a cylindrical wall part 42 standing upright from this bottom part 41, and an open end 43 formed at the front end of this cylindrical wall part 42. As depicted in FIG. 3, the heat sink 4 is fitted in the case main body 22 such that the open end 43 is located in the case 2 on the open face 21 side of the case main body 22. The cylindrical wall part 42 is disposed such that a clearance is created between the cylindrical wall part and the inner wall surface 221 of the case main body 22.

As depicted in FIG. 4, the LED module 5 is installed in the bottom part 41 in the central part of its plane. Hereinafter, the surface of the bottom part 41 on which the LED module 5 is loaded will be called an “inner surface 411”, while the surface on the opposite side shall be called an “outer surface 412”. As depicted in FIG. 4, the LED module 5 includes an LED substrate 51 and an LED 52 mounted (loaded) on this LED substrate 51. In this embodiment, the LED module 5 constitutes a so-called one-core module which has the LED 52 concentrated in the central part of the LED substrate 51. As depicted in FIG. 4, the LED module 5 according to this embodiment has one LED 52 disposed at the center of the bottom part 41 of the heat sink 4. As depicted in FIG. 4, the bottom part 41 of the heat sink 4 is flat. Thus, the flat bottom part 41 can be effectively used as the base for loading the LED module 5 on it, serving the purpose of building a one-core LED module. The LED substrate 51 is a metal-based substrate formed of a metal material, such as aluminum, having a good heat dissipation property, or of an insulating material, etc. The LED module 5 comes into thermal contact with the heat sink 4 and thereby dissipates the heat generated by the LED 52.

In the bottom part 41 of the heat sink 4, multiple through-holes 44 penetrating the bottom part 41 are disposed around the LED module 5. In this embodiment, the multiple through-holes 44 are disposed at substantially regular intervals on the outer circumferential side in the bottom part 41 so as to surround the LED 52. However, the number of the through-holes 44 is not limited to a specific number, and a single through-hole 44 may be disposed in the bottom part 41. In FIGS. 5 to 7 and 9, the LED module 5 is not depicted.

As depicted in FIG. 5 and FIG. 7, multiple heat dissipating fins 45 which are raised from the outer surface 412 are formed on the outer surface 412 side of the bottom part 41 in the heat sink 4. These heat dissipating fins 45 are provided so as to increase the surface area of the heat sink 4 and facilitate dissipation of the heat transferred from the LED 52 to the bottom part 41 of the heat sink 4. Protruding ribs 46 which protrude to the lateral side of the cylindrical wall part 42 are provided at regular intervals in the circumferential direction of the cylindrical wall part 42 in the edge part which forms the open end 43 of the cylindrical wall part 42.

Here, the inner wall surface of the cylindrical wall part 42 in the heat sink 4 will be denoted by the reference numeral 421, while the outer wall surface will be denoted by the reference numeral 422. As depicted in FIG. 8, the inner wall surface 421 of the cylindrical wall part 42 stands vertically from the inner surface 411 of the bottom part 41. The lens 7 is housed and fitted in a region defined by the inner wall surface 421 of the heat sink 4 and the inner surface 411 of the bottom part 41. In FIG. 8, the lens 7 indicated by the dotted hatching has a substantially truncated cone shape, and is, for example, formed of an acrylic resin. A recess 71 is formed in the surface of the lens 7 facing the inner surface 411 of the bottom part 41 in the heat sink 4 so that the lens 7 does not interfere with the LED 52. However, the shape, size, material, etc. of the lens 7 can be appropriately changed. In this embodiment, the lens 7 is a collective lens, and may be used, for example, for spot light applications, for example, by being adapted for narrow-angle light distribution. However, the angle of light distribution of the lens 7 can be appropriately changed, and the applications of the illumination device 1 are not limited to a specific purpose.

In this embodiment, the outer diameter of a lateral surface 72 of the lens 7 is set to be smaller than the inner diameter of the cylindrical wall part 42 in the heat sink 4. In this way, a ventilation path 9 is formed between the lateral surface 72 of the lens 7 and the inner wall surface 421 of the cylindrical wall part 42 when the lens 7 is fitted in the heat sink 4. An emission part 73 which emits the light generated by the LED 52 to the outside is formed in the front end part of the lens 7. While the lens 7 has the largest outer diameter at the position of the emission part 73, even at this position of the emission part 73, a clearance is secured as the ventilation path 9 between the lateral surface 72 and the inner wall surface 421 of the cylindrical wall part 42, and the inside and the outside of the illumination device 1 are communicated.

The heat sink 4 configured as has been described has a function as a retaining member for retaining the LED module 5 and a function as a heat dissipating member for dissipating the heat from the LED 52. The heat generated by the LED 52 is transferred to the bottom part 41 through the LED substrate 51 and dissipated from the entire heat sink 4. As will be described later, the fan 3 being an air blower is housed in the case main body 22, and the cooling air sent from the fan 3 to the heat dissipating fins 44 promotes the heat dissipation from the heat dissipating fins 44, so that the LED 52 can be efficiently cooled.

Next, referring back to FIGS. 1 to 3, the second heat sink 6 will be described in detail. The second heat sink 6 is a heat dissipating member working with the heat sink 4 to dissipate the heat of the LED 52. Similarly to the heat sink 4, the second heat sink 6 is formed of a metal material, such as aluminum, having a good heat dissipation property. The second heat sink 6 is fitted in the case 2 so as to lie between the case main body 22 and the heat sink 4.

The second heat sink 6 has a cylindrical division wall 61, and this division wall 61 gradually increases in diameter from the rear open end toward the front open end. The division wall 61 divides the cylindrical wall part 42 and the inner wall surface 221 of the case main body 22 while covering the cylindrical wall part 42 of the heat sink 4. More particularly, the division wall 61 divides the inside of the case 2 (case main body 22) such that a clearance is provided between the division wall and the outer wall surface 422 of the cylindrical wall part 42 as well as between the division wall and the inner wall surface 221 of the case main body 22.

An air outlet 31 side of the fan 3 is coupled with the rear open end of the division wall 61, and this rear open end is disposed so as to face the air outlet 31 of the fan 3. The fan 3 has multiple blades 32, and drive power is supplied to a motor (not depicted). This causes the blades 32 to rotate, sending out from the air outlet 31 the air suctioned from the side of an air inlet 33. For example, the blades 32 of the fan 3 are integrally mounted on the shaft (axis) which is pivotally supported by a bearing so as to be rotatable, and the motor rotating the shaft causes the blades 32 to rotate in conjunction therewith. Thus, the second heat sink 6 has a function as a retaining member for retaining the fan 3.

The drive power to the fan 3 and the LED module 5 (LED 52) is supplied from a power supply substrate 10 provided on the rear end side of the illumination device 1. The electronic components loaded on the power supply substrate 10 are not depicted. The base 11 for receiving a power supply from an external power source is provided on the power supply substrate 10. As the base 11 in this embodiment, for example, a type having a pin shape called GU5.3 is adopted, and the base 11 allows insertion connection with a socket (not depicted). However, the structure of connection of the base 11 with the socket is not limited to the above-described example of the insertion method, and other shapes such as a screw type may also be adopted. The power supply substrate 10 can supply a drive power supply to the fan 3 and the LED module through a connector (not depicted). As depicted in FIG. 3, the power supply substrate 10 is disposed at a position on the rear end side of the illumination device 1 (case 2). The power supply substrate 10 with various electronic components mounted on it generates heat during power supply. When the temperature of the power supply substrate power supply substrate 10 becomes high due to the heat generated from the LED 52 or the heat generated from the power supply substrate 10 itself with various electronic components mounted on it, a problem occurs such as shortening of the service life of the electronic components mounted on the power supply substrate 10. It is therefore required to make the power supply substrate 10 efficiently generate heat.

As depicted in FIG. 1 to FIG. 3, in this embodiment, the heat sink 4 is fitted in the case main body 22 through the second heat sink 6. That is, the second heat sink 6 has a function as a retaining member for retaining the heat sink 4. A protruding edge part 62 which protrudes further to the front side than the open face 21 of the case main body 22 is formed on the front open end side of the division wall 61 in the second heat sink 6. Similarly, in the heat sink 4, a protruding edge part 47 is formed by the open end 43 side of the cylindrical wall part 42 protruding further to the front side than the open face 21 of the case main body 22. The protruding edge part 47 of the heat sink 4 corresponds to the second protruding edge part in the present invention. The protruding edge part 62 of the second heat sink 6 protrudes further to the lateral side (in the radial direction) of the division wall 61 than the other portions. That is, the outer diameter of the protruding edge part 62 of the second heat sink 6 is larger than the other portions by one step and a level difference is provided at the boundary between the protruding edge part 62 and the other portions.

Here, the outer circumferential surface of the protruding edge part 47 of the heat sink 4 is disposed so as to face the inner circumferential surface of the protruding edge part 62 of the second heat sink 6. The above-described protruding ribs 46 of the heat sink 4 are disposed side by side on the outer circumferential surface of the protruding edge part 47. To describe the protruding rib 46 in more detail, the protruding rib 46 protrudes from the outer circumferential surface of the protruding edge part 47 in the heat sink 4 so as to abut on the protruding edge part 62 of the second heat sink 6. The protruding rib 46 leaves part of the clearance between the protruding edge part 62 of the second heat sink 6 and the protruding edge part 47 in the heat sink 4 as the air discharge port 12 while covering the rest of the clearance.

Next, the ventilation passage and the air discharge passage in the illumination device 1 will be described. As depicted in FIG. 3, the air intake port 13 for taking the outside air into the illumination device 1 is formed as a clearance created between the rear end part of the protruding edge part 62 of the second heat sink 6 and the front end edge part on the open face 21 side of the case main body 22. The air intake passage 14 which communicates between the air inlet 33 of the fan 3 and the above-described air intake port 13 is formed along the inner wall surface 221 of the case main body 22 inside the case main body 22. The air intake passage 14 guides to the fan 3 the air (outside air) introduced from the lateral side of the case main body 22 through the air intake port 13 to the inside of the case main body 22. More particularly, the air intake passage 14 is formed as a clearance between the inner wall surface 221 of the case main body 22 and an outer wall surface 611 of the division wall 61 of the second heat sink 6. The heat sink 4 and the second heat sink 6 are fixed to the case 2 by the fixing member 8 which is, for example, a screw.

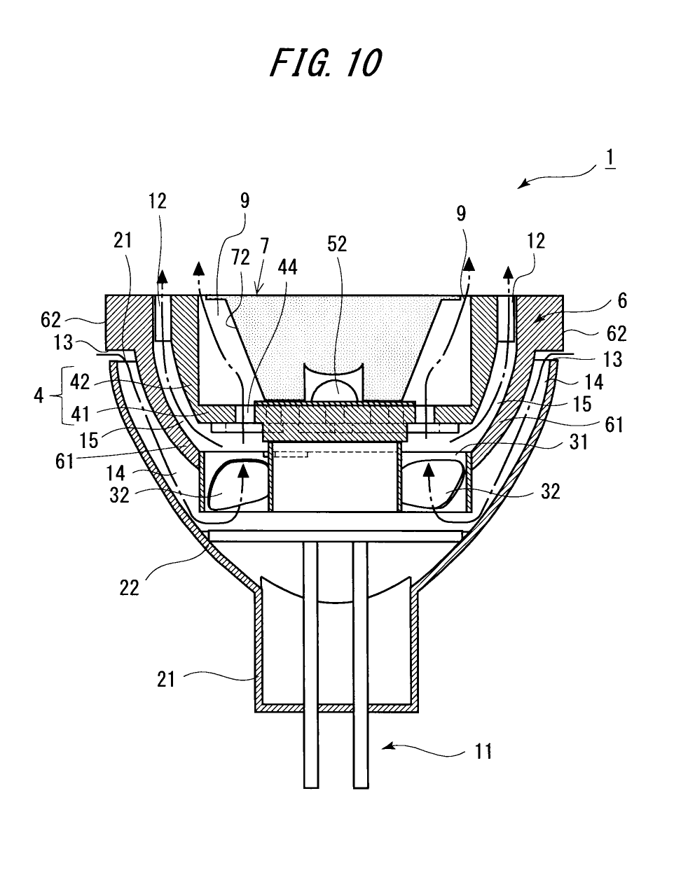

FIG. 10 is a view illustrating an air flow in the illumination device 1. In FIG. 10, the air flow is schematically indicated by the dot-dashed arrow. The outside air taken into the case main body 22 from its lateral side through the air intake port 13 is guided to the air inlet 33 of the fan 3 through the air intake passage 14. Then, the air suctioned from the air inlet 33 of the fan 3 is sent out from the air outlet 31. The air sent out from the air outlet 31 of the fan 3 is blown forcefully against the outer surface 412 of the bottom part 41 in the heat sink 4 disposed so as to face the air outlet 31. As a result, the heat transferred from the LED module 5 is dissipated from the bottom part 41 in the heat sink 4 and thereby the LED 52 of the LED module 5 is cooled. In this embodiment, the heat dissipating fin 45 is formed on the outer surface 412 side of the bottom part 41 in the heat sink 4. This further promotes dissipation of the heat transferred from the LED module 5, so that the LED 52 can be efficiently cooled.

The air blown against the outer surface 412 of the bottom part 41 in the heat sink 4 is discharged to the outside from the air discharge port 12 formed on the front end side of the heat sink 4 through the air discharge passage 15 formed along the outer surface 412 of the bottom part 41 and the outer wall surface 422 of the cylindrical wall part 42. More particularly, the air discharged to the outside through the air discharge passage 15 is discharged to the outside toward the front side of the illumination device 1, from the air discharge port 12 via the clearance between the outer wall surface 422 of the cylindrical wall part 42 of the heat sink 4 and the inner wall surface 612 of the division wall 61 of the second heat sink 6.

Part of the cooling air (air) blown from the fan 3 toward the outer surface 412 of the bottom part 41 in the heat sink 4 passes through the multiple through-holes 44 provided in the bottom part 41 and is sent to the LED module 5 side. Here, since the cooling air removes the heat of the bottom part 41 while passing through the through-holes 44, cooling of the LED module 5 can be further promoted. The air having passed through the through-holes 44 can be discharged to the outside toward the front side of the illumination device 1 via the ventilation path 9 formed between the lateral surface 72 of the lens 7 and the inner wall surface 421 of the cylindrical wall part 42. In this embodiment, the configuration is adopted in which the LED 52 is covered with the lens 7; however, for example, the lens 7 may be configured such that the air having passed through the through-holes 44 can come into direct contact with the LED 52. In this case, the LED 52 can be directly cooled with the cooling air supplied through the through-holes 44, so that the cooling efficiency of the LED 52 can be further enhanced.

Thus, in the illumination device 1 according to this embodiment, double suction of suctioning the discharged warm air again from the air intake port 13 can be prevented by introducing the outside air from the lateral side of the case main body 22 and discharging the air heated due to the heat from the LED 52 to the front side of the case main body 22. In addition, since the air discharge passage 15 is formed along the outer wall surface 422 of the cylindrical wall part 42 in the heat sink 4, the freedom is sufficiently secured in the aspect in which the LED module 5 is installed in the bottom part 41 of the heat sink 4. That is, since the central part of the bottom part 41 of the heat sink 4 is available as the installation space of the LED module 5 in this embodiment, the LED module 5 can be constituted as a one-core type. While in this embodiment, the through-holes 44 are bored in the bottom part 41 of the heat sink 4 in order to further enhance the cooling efficiency of the LED 52, the provision of this through-hole 44 is not essential. In this case, the entire surface of the bottom part 41 of the heat sink 4 is available as the installation space of the LED module 5.

In the illumination device 1 of this embodiment, the structure is adopted in which the second heat sink 6, in which the heat sink 4 is fitted, is provided between the heat sink 4 and the case main body 22, and the air intake passage 14 and the air discharge passage 15 are divided by the division wall 61 of the second heat sink 6. According to this structure, disturbance of the air flow due to interference between the air flowing through the air intake passage 14 from the air intake port 13 toward the fan 3 and the air flowing through the air discharge passage 15 from the fan 3 toward the air discharge port 12 can be prevented. Moreover, since the second heat sink 6 and the heat sink 4 are in thermal contact with each other, the heat capacity of the heat sink as a whole increases, so that the cooling effect on the LED 52 can be enhanced.

Moreover, according to the illumination device 1, the air intake passage 14 is formed by the inner wall surface 221 of the case main body 22 and the division wall 61 of the second heat sink 6, while the air discharge passage 15 is formed by the cylindrical wall part 42 of the heat sink 4 and the division wall 61 of the second heat sink 6. Thus, a sufficient chance can be secured for the air to come into contact with the heat sink 4 or the second heat sink 6 after the air is suctioned from the air intake port 13 and before it is discharged from the air discharge port 12. Thus, the cooling efficiency of the LED 52 can be enhanced. In the illumination device 1, the power supply substrate 10 is disposed at a position where it can undergo direct heat exchange with the air passing through the air intake passage 14. Thus, when the air at a relatively low temperature introduced from the outside through the air intake port 13 passes through the air intake passage 14, the power supply substrate 10 can be directly cooled by the air.

Thus, in the illumination device 1 which performs active cooling of the LED 52 using the fan 3, the freedom is secured in the aspect in which the LED module 5 is installed, and moreover, it is possible to enhance the cooling efficiency while preventing the warm air having been discharged once from being suctioned again. As a result, the luminous efficiency of the illumination device 1 having the LED as a light source can be improved.

In Embodiment 1, the air intake passage 14 communicating between the air inlet 33 of the fan 3 and the air intake port 13 corresponds to a first ventilation path of the present invention, while the air discharge passage 15 formed along the outer surface 412 of the bottom part 41 and the outer wall surface 422 of the cylindrical wall part 42 in the heat sink 4 corresponds to a second ventilation path of the present invention (see FIG. 3).

### MODIFIED EXAMPLE

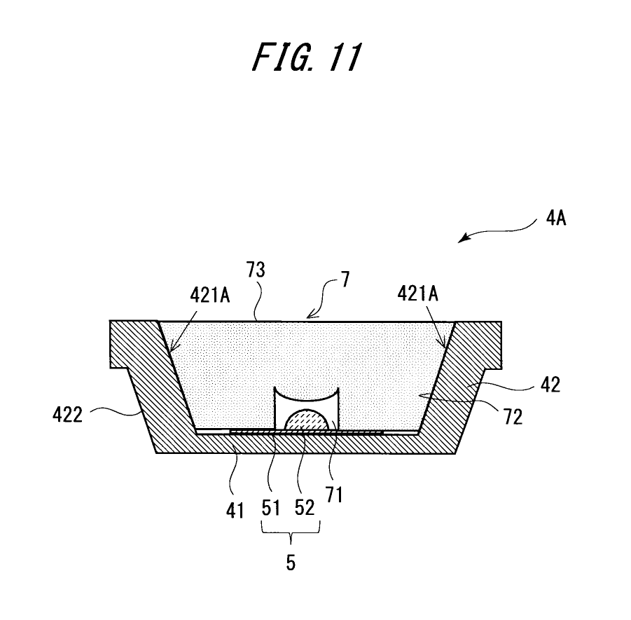

Next, a modified example will be described. FIG. 11 is a cross-sectional view of a heat sink 4A according to a modified example of Embodiment 1. The detailed description of the configurations which are the same as those of the above-described heat sink 4 will be omitted by denoting them by the same reference numerals. In the heat sink 4A, no through-hole 44 is formed in the bottom part 41. Similarly to the heat sink 4, the LED module 5 is installed in the bottom part 41.

In the heat sink 4A according to this modified example, an inner wall surface 421A in the cylindrical wall part 42 standing upright from the bottom part 41 is formed as a reflector which reflects the light generated by the LED 52. The heat sink 4A thus adapted to function as a reflector can control an optical characteristic such as an angle of light distribution. The extraction efficiency of the light generated by the LED 52 can also be improved. Also in the heat sink 4A according to this modified example, the through-hole 44 may be provided in the bottom part 41 as in the heat sink 4.

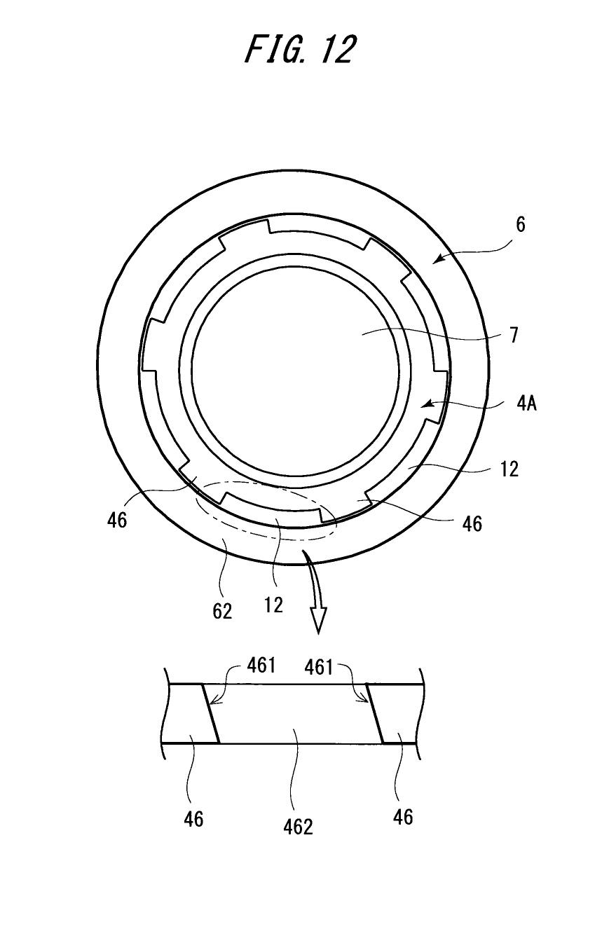

FIG. 12 illustrates the structure of the air discharge port 12 according to a modified example of Embodiment 1. In the upper part, a front view of the illumination device 1 according to the modified example is depicted. In the lower part, a side view of the portion circled by the dot-dashed line in the figure is schematically depicted. Here, of the protruding ribs 46 provided in the protruding edge part 47 according to the heat sink 4A, the wall surface extending from the protruding edge part 47 toward the protruding edge part 62 of the second heat sink 6 is called a “protruding wall surface 461”, while the wall surface which is connected with a pair of protruding wall surfaces 461 and faces the protruding edge part 62 is called a “circumferential wall surface 462”. In this modified example, of the adjacent ones of the protruding ribs 46, a pair of opposite protruding wall surfaces 461 forming one of the air discharge ports 12 is inclined in the circumferential direction of the protruding edge part 47 and in the same direction.

In this way, inclining the pair of opposite protruding wall surfaces 461 of the pair of opposite protruding wall surfaces 461, the circumferential wall surface 462, and the inner wall surface of the protruding edge part 62, which define one of the air discharge ports 12, in the same direction and in the circumferential direction of the protruding edge part 47 allows the structure of the air discharge port 12 with a passage twisted from the rear end side toward the front end side in the circumferential direction. This allows smooth discharge of the air from the air discharge port 12, so that the flow rate of the air discharged from the air discharge port 12 increases. That is, the supply amount of the cooling air supplied from the fan 3 to the heat sink 4A increases, and the cooling efficiency of the LED 52 can be enhanced. The air sent out from the fan 3 flows as a swirl flow through the air discharge passage 15. In this connection, twisting the air discharge port 12 as described above in the circumferential direction of the protruding edge part 47 can eliminate disturbance of the flow of the swirl flow guided through the air discharge passage 15 to the air discharge port 12. As a result, the air can be smoothly discharged from the air discharge port 12, so that the cooling efficiency of the LED 52 can be enhanced. Due to depiction of FIG. 12, there seems to be a clearance between the wall surface in the circumferential direction connected by the pair of protruding wall surfaces 461 of the wall surfaces forming the one protruding rib 46 and the inner wall surface of the protruding edge part 62, both the wall surfaces are actually abut on each other. However, the modified example is not limited to the above-described aspect, and a clearance may be provided between the wall surface in the circumferential direction connected with the pair of protruding wall surfaces 461 in the protruding rib 46 and the inner wall surface of the protruding edge part 62 opposite to the wall surface in the circumferential direction.

### Embodiment 2

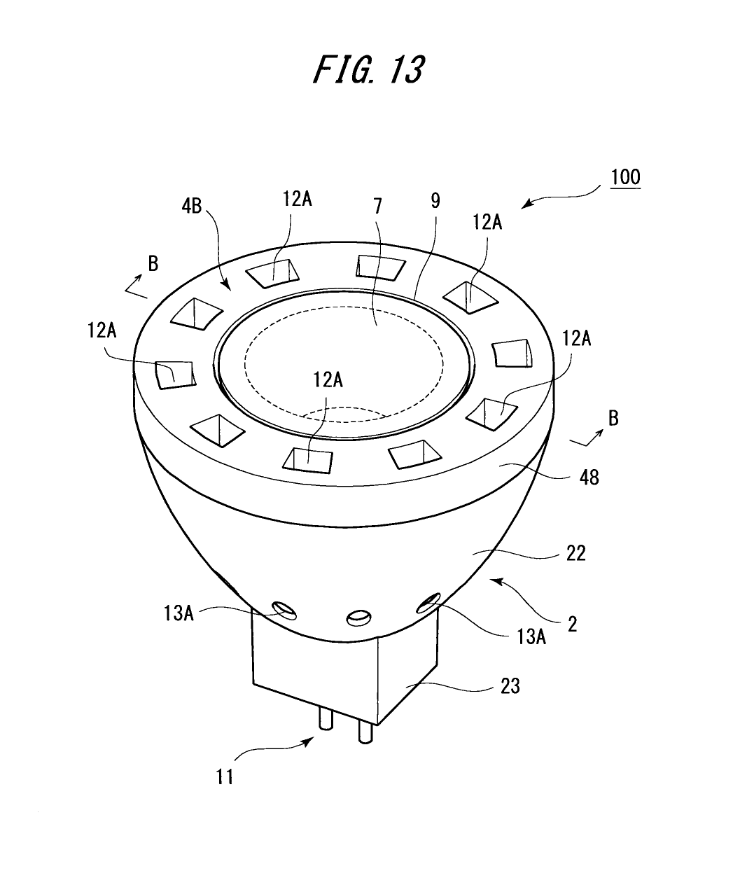

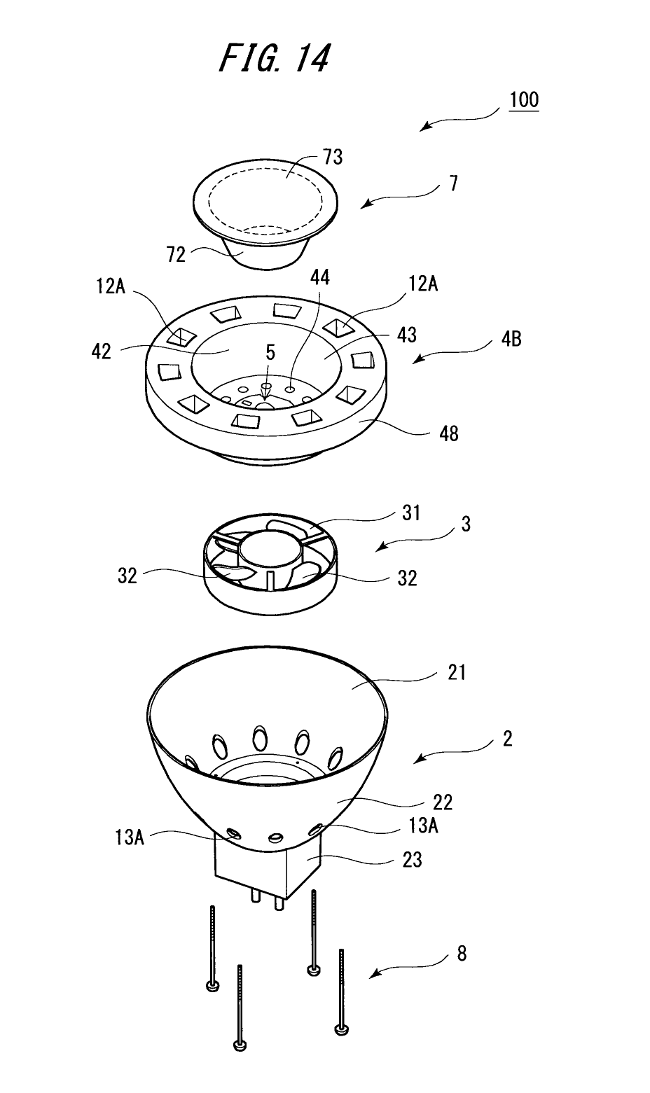

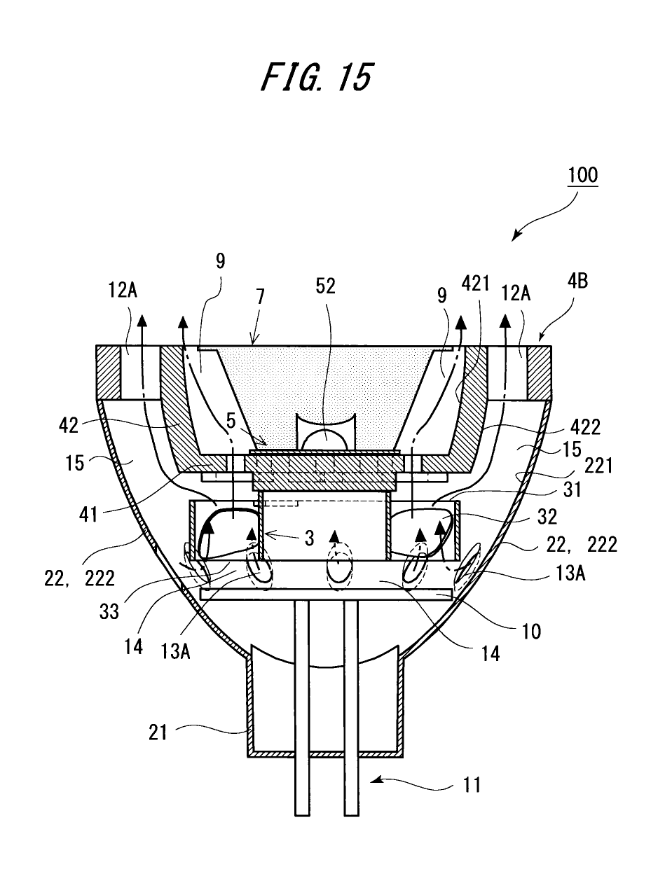

FIG. 13 is an outline perspective view of an illumination device 100 according to Embodiment 2. FIG. 14 is an exploded perspective view of the illumination device 100 according to Embodiment 2. FIG. 15 is a cross-sectional view of the illumination device 100 according to Embodiment 2. FIG. 15 is a cross-sectional view along the line B-B of FIG. 13. Of the constituent members of the illumination device 100, the detailed description of those that are common with the illumination device 1 according to Embodiment 1 will be omitted by denoting them with the same reference numerals.

The illumination device 100 includes the case 2, the fan 3, a heat sink 4B, the LED module 5, the lens 7, the fixing member 8, etc. The illumination device 100 according to this embodiment does not include the second heat sink 6. The heat sink 4 is formed with a collar part 48 which protrudes to the lateral side compared with the other portions on the open end 43 side formed at the front end of the cylindrical wall part 42. The outer diameter of the collar part 48 is equal to the outer diameter of the case main body 22. Moreover, the collar part 48 protrudes further to the front side than the open face 21 of the case main body 22. An air discharge port 12A penetrating the collar part 48 in the thickness direction is formed in the collar part 48.

The fan 3 is housed in the case main body 22 so as to face the outer surface 412 of the bottom part 41 of the heat sink 4B. The aspect in which the LED module 5 and the lens 7 are mounted on the heat sink 4B is common with the illumination device 1 according to Embodiment 1. An air intake port 13A communicating with the air intake passage 14 is formed at a position on the rear side of the position where the air outlet 31 of the fan 3 housed in the case main body 22 is disposed. Specifically, the air intake port 13A is provided at a position near the air inlet 33 of the fan 3 in the outer wall surface 222 of the case main body 22. Multiple air intake ports 13A are provided in the case main body 22, and the air intake ports 13A are formed at regular intervals in the circumferential direction of the outer wall surface 222.

The air intake passage 14 communicating between the air inlet 33 of the fan 3 and the air intake port 13A is formed inside the case main body 22. The air discharge passage 15 is formed along the reference numeral 422 on the outer surface 412 of the bottom part 41 and the outer wall surface of the cylindrical wall part 42 in the heat sink 4B.

According to the illumination device 100 thus configured, the outside air is introduced from the air intake port 13A provided on the lateral side of the case main body 22, and the air warmed by the heat from the LED 52 is discharged from the air discharge port 12A to the front side of the case main body 22. Therefore, double suction of the warm air having been discharged once from the illumination device 100 being suctioned again from the air intake port 13A can be avoided. According to the illumination device 100, the air discharge passage 15 is formed along the outer wall surface 422 of the cylindrical wall part 42 in the heat sink 4B, so that the freedom can be sufficiently secured in the aspect in which the LED module 5 is installed in the bottom part 41 of the heat sink 4. Moreover, since the air discharge passage 15 is formed by the outer wall surface 422 of the cylindrical wall part 42 in the heat sink 4B, a sufficient chance can be secured for the cooling air flowing through the air discharge passage 15 to come into contact with the heat sink 4B. This promotes heat dissipation from the heat sink 4B, and the cooling efficiency of the LED 52 can be further enhanced. In the illumination device 100, the air intake port 13A is provided in a portion closer to the rear end of the case 2 than to the fan 3. Thus, the air taken into the air intake passage 14 from the air intake port 13A and the power supply substrate 10 can be subjected to direct heat exchange. As a result, the power supply substrate 10 can be directly cooled by the air at a relatively low temperature introduced from the outside through the air intake port 13A while passing through the air intake passage 14.

Therefore, according to the illumination device 100 related to this embodiment, as with the illumination device 1 according to Embodiment 1, the freedom is secured in the aspect in which the LED module 5 is installed, and moreover, it is possible to enhance the cooling efficiency while preventing the warm air having been discharged once from being suctioned again. Thus, the luminous efficiency of the illumination device 100 can be further improved. Moreover, according to the illumination device 100, the manufacturing cost can be reduced since it does not include the second heat sink 6.

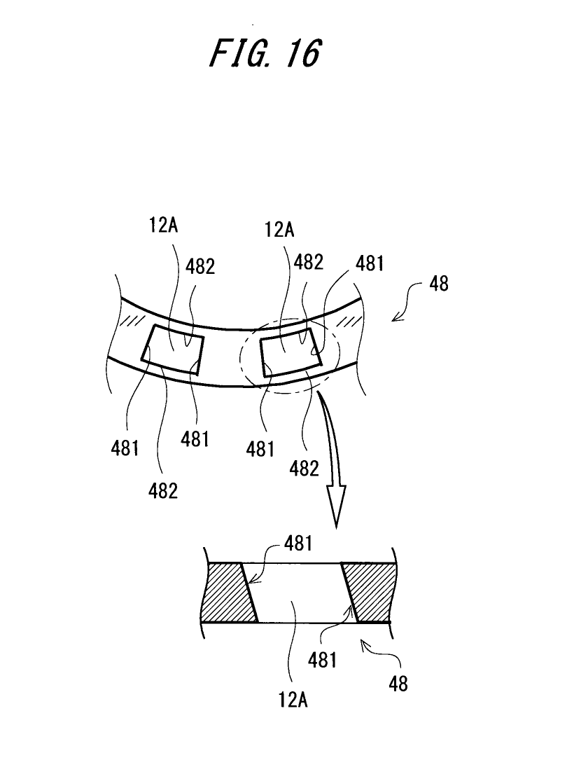

Also in the illumination device 100 according to this embodiment, various changes can be made within the range not departing from the scope of the present invention. FIG. 16 is a view illustrating a modified example of the heat sink 4B according to this embodiment. In the upper part of FIG. 16, a front view of a portion of the collar part 48 in the heat sink 4B is depicted. Each of the air discharge ports 12A provided in the collar part 48 is defined by a pair of wall surfaces 481 along the radial direction of the collar part 48 and a pair of wall surfaces 482 along the circumferential direction of this collar part 48. In FIG. 16, the lower part depicts the cross-sectional structure of the portion circled by the dashed line. As depicted, the pair of wall surfaces 481 along the radial direction of the collar part 48 which defines the air discharge port 12A together with the pair of wall surfaces 482 along the circumferential direction of the collar part 48 is inclined in the circumferential direction of the collar part 48 and in the same direction, as depicted in the cross-section in the lower part.

As described above, the structure of the air discharge port 12 with the passage twisted in the circumferential direction from the rear end side toward the front end side allows the air to be discharged smoothly from the air discharge port 12, so that the flow rate of the air discharged from the air discharge port 12 increases. That is, the supply amount of the cooling air supplied from the fan 3 to the heat sink 4B increases, and the cooling efficiency of the LED 52 can be enhanced.

In Embodiment 2, the air intake passage 14 communicating between the air inlet 33 of the fan 3 and the air intake port 13A corresponds to the first ventilation path of the present invention, while the air discharge passage 15 which is formed inside the case main body 22 along the reference numeral 422 on the outer surface 412 of the bottom part 41 and the outer wall surface of the cylindrical wall part 42 in the heat sink 4B corresponds to the second ventilation path of the present invention (see FIG. 15).

Various modifications can be made to the embodiments having been described so far. For example, in the illumination devices depicted in FIGS. 3 and 15, the air intake passage 14 and the air discharge passage 15 may be reversed. In other words, the outside air may be introduced to the inside from the front end side of the heat sink and guided to the fan 3 using the ventilation path indicated by the reference numeral 15 depicted in FIGS. 10 and 15, and the air from the fan 3 may be discharged to the outside from the lateral side of the case 2 by using the ventilation path indicated by the reference numeral 14.

### Embodiment

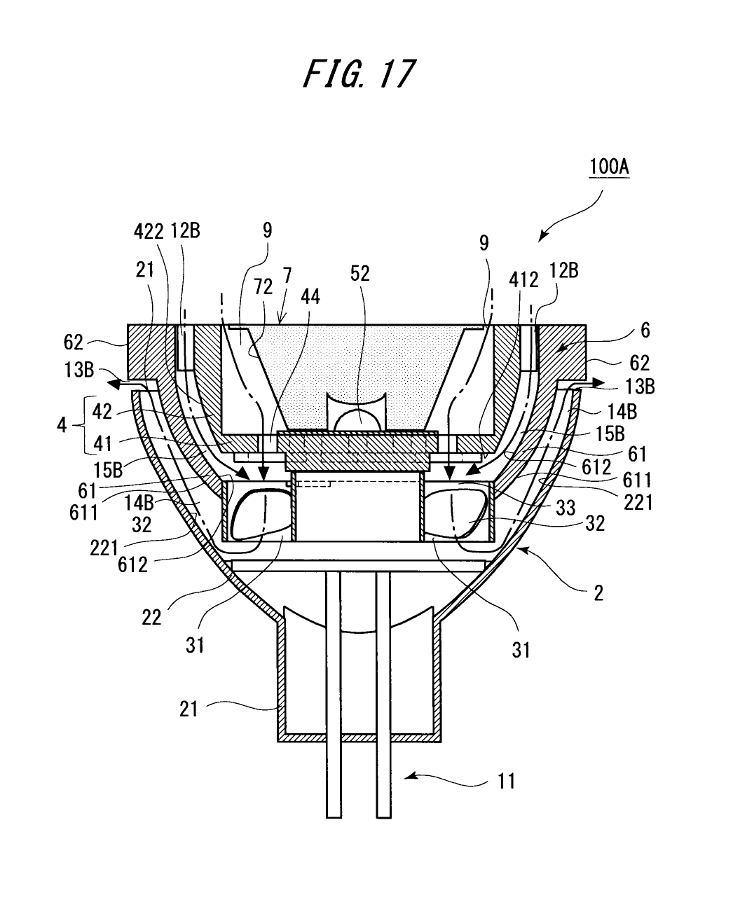

FIG. 17 is a cross-sectional view of an illumination device 100A according to Embodiment 3. The illumination device 100A of this embodiment corresponds to an illumination device with the air intake passage 14 and the air discharge passage 15, and the air discharge port 12 and the air intake port 13 of the illumination device 1 depicted in FIG. 3 reversed. In the following, differences in the illumination device 100A from the illumination device 1 will be mainly described, while the description of the common features will be appropriately omitted. In FIG. 17, the reference symbol 12B denotes an air intake port, 13B denotes an air discharge port, 14B denotes an air discharge passage, and 15B denotes an air intake passage. Other configurations are common with the illumination device 1 depicted in FIG. 3. The air intake port 12B, the air discharge port 13B, the air discharge passage 14B, and the air intake passage 15B are the same in position and structure with the air discharge port 12, the air intake port 13, the air intake passage 14, and the air discharge passage 15 depicted in FIG. 3 but opposite in the direction of the air flow. In the illumination device 100A depicted in FIG. 17, driving the fan 3 to rotate causes the outside air to be introduced into the case 2 from the front end side of the heat sink 4 through the air intake port 12B. The air intake passage 15B is famed along the outer wall surface 422 of the cylindrical wall part 42 and the outer surface 412 of the bottom part 41 in the heat sink 4 so as to communicate between the air intake port 12B and the air inlet 33 of the fan 3. More particularly, the air intake passage 15B is formed as a clearance between the outer wall surface 422 of the cylindrical wall part 42 of the heat sink 4 and the inner wall surface 612 of the division wall 61 in the second heat sink 6. The air intake passage 15B guides the air introduced from the air intake port 12B formed on the front end side of the heat sink 4 to the fan 3.

On the other hand, the air discharge port 13B is formed on the lateral side of the case 2 as a clearance created between the rear end part of the protruding edge part 62 of the second heat sink 6 and the front end edge part on the open face 21 side of the case main body 22. The air discharge passage 14B is formed as a clearance between the inner wall surface 221 of the case main body 22 and the outer wall surface 611 of the division wall 61 in the second heat sink 6. The air discharge passage 14B communicates between the air outlet 31 of the fan 3 and the air discharge port 13B, and guides the air from the fan 3 to the air discharge port 13B. The air having passed through the air discharge passage 14B is released to the outside from the air discharge port 13B opened toward the outside on the lateral side of the case 2.

The fan 3 in the illumination device 100A is driven to rotate in the direction opposite to that of the fan 3 in the illumination device 1 according to Embodiment 1, and the air outlet 31 is disposed to face the rear side of the case 2, and the air inlet 33 is disposed to face the front side of the case. The dashed arrows in FIG. 17 schematically indicate the flow of the air flowing inside the case 2. In the illumination device 100A configured as described above, the outside air taken to the inside from the front end side of the case 2 through the air intake port 12B is guided to the air inlet 33 of the fan 3 through the air intake passage 15B. Here, the air intake passage 15B is formed along the outer surface 412 of the bottom part 41 and the outer wall surface 422 of the cylindrical wall part 42 in the heat sink 4. Thus, when the air at a relatively low temperature introduced from the outside passes through the air intake passage 15B, the heat transferred from the LED 52 of the LED module 5 through the heat sink 4 is efficiently dissipated. When the air sent from the air outlet 31 of the fan 3 passes through the air discharge passage 14B formed as a clearance between the inner wall surface 221 of the case main body 22 and the outer wall surface 611 of the division wall 61 in the second heat sink 6, heat is exchanged between the division wall 61 of the second heat sink 6 and the air flowing through the air discharge passage 14B. In this way, the heat generated by the LED 52 and transferred to the second heat sink 6 side through the heat sink 4 can be favorably dissipated also from the division wall 61 side of the second heat sink 6. Thus, during the course in which the outside air taken into the case 2 through the air intake port 12B passes through the air intake passage 15B and is discharged to the outside from the air discharge port 13B via the air discharge passage 14B, the air flowing through the air intake passage 15B and the air discharge passage 14B removes the heat generated from the LED 52 through the heat sink 4 and the second heat sink 6, so that the LED 52 can be favorably cooled. As depicted in FIG. 17, the illumination device 100A has the ventilation path 9 formed between the lateral surface 72 of the lens 7 and the inner wall surface 421 of the cylindrical wall part 42, and this ventilation path 9 is opened to the outside on the front end side of the case 2. The air inflowing from the front end side of the case 2 and from the ventilation path 9 passes through the multiple through-holes 44 provided in the bottom part 41 of the heat sink 4 and is guided to the air inlet 33 of the fan 3. The air passing through the ventilation path 9 and the through-holes 44 removes heat transferred directly from the LED 52 of the LED module 5 or the heat transferred from the LED 52 to the bottom part 41, so that cooling of the LED module 5 can be further promoted.

As described above, the air after removing the heat of the LED module 5 (LED 52) is sent to the air discharge passage 14B from the air outlet 31 of the fan 3. Then, the air sent out from the fan 3 passes through the air discharge passage 14B and is discharged toward the outside on the lateral side of the case 2 from the air discharge port 13B. The air warmed by removing the heat of the LED 52 is at a temperature higher than the temperature of the outside air and hence is at a density lower than the outside air. Thus, the air discharged to the outside form the lateral side of the case 2 moves upward. Since the illumination device 100A in this embodiment introduces the outside air from the front side of the case main body 22 and discharges the air heated by the heat removed from the LED 52 to the lateral side of the case main body 22, when the illumination device 100A is used with its front end side facing downward (i.e., with its light emission direction oriented downward), the air at a high temperature discharged from the air discharge port 13B moves to the rear end side of the illumination device 100A due to the difference in density from the outside air. Therefore, when the front-side air intake/lateral-side air discharge method is adopted as with the illumination device 100A according to this embodiment, installing the illumination device 100A with its front end side facing downward (with its light emission direction oriented downward) can more favorably prevent the double suction of the warm air having been discharged from the air discharge port 13B being suctioned again from the air intake port 12B. In this way, the cooling efficiency of the LED 52 in the LED module 5 is enhanced, and an illumination device which can improve the luminous efficiency can be realized.

### Embodiment

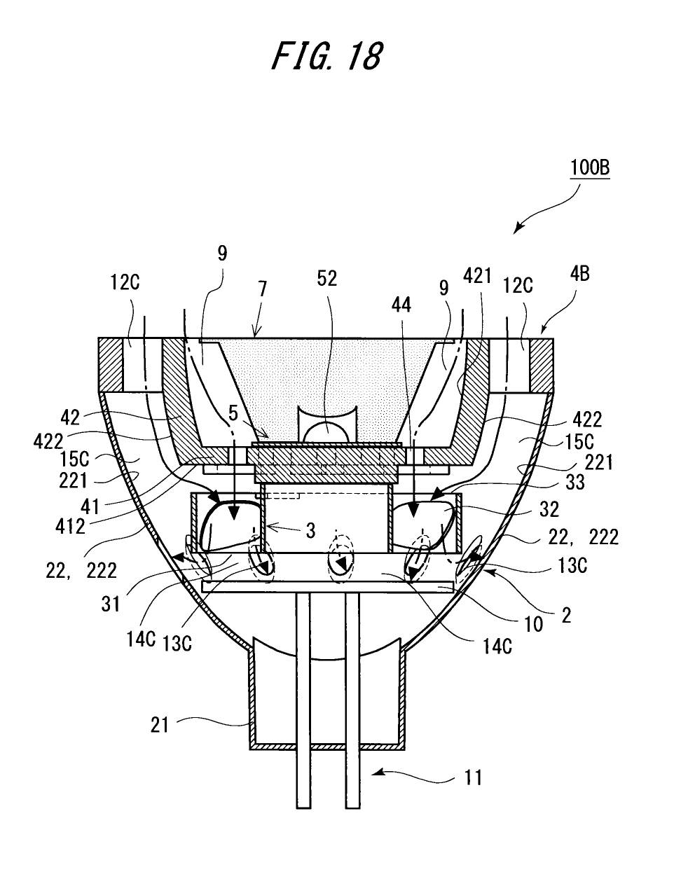

FIG. 18 is a cross-sectional view of an illumination device 100B according to Embodiment 4. The illumination device 100B of this embodiment corresponds to an illumination device with the air intake passage 14 and the air discharge passage 15, and the air discharge port 12A and the air intake port 13A of the illumination device 100 depicted in FIG. 15 reversed. In the following, differences in the illumination device 100B from the illumination device 100 will be mainly described, while the description of common features will be appropriately omitted. In FIG. 18, the reference symbol 12C denotes an air intake port, 13C denotes an air discharge port, 14C denotes an air discharge passage, and 15C denotes an air intake passage. Other configurations are common with the illumination device 100 depicted in FIG. 15.

The air intake port 12C, the air discharge port 13C, the air discharge passage 14C, and the air intake passage 15C are the same in position and structure with the air discharge port 12A, the air intake port 13A, the air intake passage 14, and the air discharge passage 15 depicted in FIG. 15, but the direction of air flow is opposite. In the illumination device 100B depicted in FIG. 18, driving the fan 3 to rotate causes the outside air to be introduced into the case 2 from the front end side of the heat sink 4 through the air intake port 12C. The air intake port 12C is formed to penetrate the collar part 48 of the heat sink 4B in the thickness direction. The air intake passage 15C communicates between the air intake port 12C and the air inlet 33 of the fan 3, and is formed along the outer surface 412 of the bottom part 41 and the outer wall surface 422 of the cylindrical wall part 42 in the heat sink 4B. The air intake passage 15C guides the air introduced from the air intake port 12B formed on the front end side of the heat sink 4B to the air inlet 33 of the fan 3.

On the other hand, the air discharge port 13C is formed at a position on the rear side of the position where the air outlet 31 of the fan 3 housed in the case main body 22 is disposed in the outer wall surface 222 located on the lateral side of the case main body 22, and communicates between the inside and the outside of the case 2. The air discharge passage 14C communicates between the air outlet 31 of the fan 3 and the air discharge port 13C, and guides the air from the fan 3 to the air discharge port 13C. The air having passed through the air discharge passage 14C is discharged to the outside from the air discharge port 13C opened toward the outside on the lateral side of the case 2.

The fan 3 in the illumination device 100B is driven to rotate in the direction opposite to that of the fan 3 of the illumination device 100 according to Embodiment 2, and the air outlet 31 is disposed to face the rear side of the case 2 and the air inlet 33 is disposed to face the front side of the case. The dashed arrows in FIG. 18 schematically indicate the flow of air flowing inside the case 2. In the illumination device 100B configured as described above, the outside air taken to the inside from the front end side of the case 2 through the air intake port 12C is guided to the air inlet 33 of the fan 3 through the air intake passage 15C. Here, the air intake passage 15C is formed along the outer wall surface 422 of the cylindrical wall part 42 and the outer surface 412 of the bottom part 41 in the heat sink 4B. Thus, when the air at a relatively low temperature introduced from the outside through the air intake port 12C passes through the air intake passage 15C, the heat transferred from the LED 52 of the LED module 5 through the heat sink 4B is efficiently dissipated. As depicted in FIG. 18, the illumination device 100B has the ventilation path 9 formed between the lateral surface of the lens 7 and the inner wall surface 421 of the cylindrical wall part 42, and this ventilation path 9 is opened to the outside on the front end side of the case 2. The air flowing into the case 2 from the front end side and from the ventilation path 9 passes through the multiple through-holes 44 provided in the bottom part 41 of the heat sink 4 and is guided to the air inlet 33 of the fan 3. The air passing through the ventilation path 9 and the through-holes 44 directly removes the heat from the LED 52 of the LED module 5, or removes the heat transferred from the LED 52 to the bottom part 41, so that cooling of the LED module 5 can be further promoted.

As described above, the air after removing the heat of the LED module 5 (LED 52) is sent to the air discharge passage 14C from the air outlet 31 of the fan 3. Then, the air sent out from the fan 3 passes through the air discharge passage 14C and is discharged toward the outside on the lateral side of the case 2 from the air discharge port 13C. The air warmed by removing the heat of the LED 52 is at a temperature higher than the temperature of the outside air and hence is at a density lower than the outside air. Thus, the air discharged to the outside form the lateral side of the case 2 moves upward. Since the illumination device 100B in this embodiment introduces the outside air from the front side of the case 2 and discharges the air heated by the heat removed from the LED 52 to the lateral side of the case main body 2, when the illumination device 100B is used with its front end side facing downward (i.e., with its light emission direction oriented downward), the air at a high temperature discharged from the air discharge port 13C moves to the rear end side of the illumination device 100B due to the difference in density from the outside air. Therefore, when the front-side air intake/lateral-side air discharge method is adopted as with the illumination device 100B according to this embodiment, installing the illumination device 100B with its front end side facing downward (with its light emission direction oriented downward) can more favorably prevent the double suction of the warm air having been discharged from the air discharge port 13C being suctioned again from the air intake port 12C. In this way, the cooling efficiency of the LED 52 in the LED module 5 is enhanced, and an illumination device which can improve the luminous efficiency can be realized.

A simulation was conducted as to the case where the fan 3 was operated and the case where it was not in the illumination devices according to Embodiments 2 and 4 having been described so far to confirm the cooling effect on the LED 52. The simulation was conducted under a condition of the light emission direction set to the downward direction. In the illumination device according to Embodiment 2, when the fan 3 was not operated, the temperature of the LED 52 reached approximately 150° C., whereas operating the fan 3 successfully cooled the LED 52 to approximately 85° C. When the fan 3 was operated in the illumination device according to Embodiment 4, the LED 52 was successfully cooled to approximately 81° C. As a comparative example, a simulation conducted on the illumination device of the type which takes in the outside air from the front side of the case and discharges the air also from the front side found that the temperature of the LED when the fan was not operated was approximately 145° C., and even with the fan being operated, the temperature of the LED was cooled only to 107° C. This proves that, in contrast to the comparative example, according to the illumination device which takes in the outside air from the front side of the case while discharging the air from the lateral side of the case, or takes in the outside air from the lateral side of the case while discharging the air from the front side of the case, the cooling efficiency of the LED can be enhanced compared with the above-described comparative example. Since the air discharged from the illumination device has been warmed by heat exchange with the heat sink, it is discharged at a temperature higher than the temperature of the outside air. Thus, when the air is discharged from the front end side (front side) of the illumination device, the high-temperature air discharged from the illumination device is lower in density than the outside air and moves upward. A possible explanation of why the simulation result corresponding to the illumination device according to Embodiment 4 showed more efficient cooling of the LED than the simulation corresponding to the illumination device according to Embodiment 2 is that, when the illumination device adopting the front-side air intake/lateral-side air discharge method as Embodiment 4 is used in a downward-facing position, the high-temperature air discharged from the lateral side of the device moves to the rear end side of the device, which more preferably prevents the double suction of the warm air.

### Other Modified Examples

In each of the embodiments having been described so far, it is preferable that a treatment for improving thermal emissivity is performed on the surface of the heat sink (heat sinks 4, 4B, and the second heat sink 6). Various treatments for improving thermal emissivity are conceivable, such as performing a surface treatment to improve the thermal emissivity, forming a thermal emissivity improving film by coating, and forming a thermal emissivity improving film by immersion in a thermal emissivity improving liquid. For the above-mentioned thermal emissivity improving film, for example, a paint containing silicon carbide or a predetermined special ceramic is preferably used. Specifically, Cooltech CT200 of Okitsumo Incorporated, or UNI Cool (water-based type II) of Godo Printing Ink Mfg. Co., Ltd., etc. can be used for the thermal emissivity improving film. By thus performing a treatment for improving thermal emissivity on the surface of the heat sink, the heat dissipation through heat emission of the heat sink can be further improved. Accordingly, the heat generated from the LED 52 can be sufficiently dissipated, so that the LED 52 can be effectively prevented from being at a high temperature. In a treatment for improving the thermal emissivity of the heat sink, the treatment is not limited to the case where a treatment for improving the thermal emissivity is performed on the entire surface of the heat sink, but the treatment for improving the thermal emissivity may also be performed only on part of the surface of the heat sink.

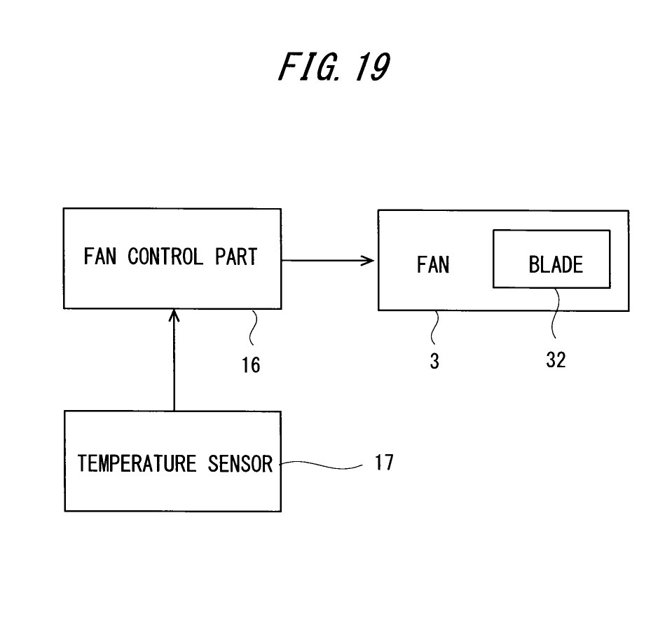

In another modified example, the illumination device may include a fan control part which controls the rotation direction and the rotation speed of the blades 32 constituting the fan. FIG. 19 is a block diagram depicting the configuration for controlling the rotation of the blades 32 constituting the fan 3. As depicted in FIG. 19, the illumination device includes a fan control part 16 and a temperature sensor 17 as a configuration for controlling the rotation of the blade 32 of the fan 3. For example, the temperature sensor 17 is installed in the LED substrate 51 to detect the temperature of the LED 52. The temperature sensor 17 transmits temperature information indicating the detected temperature of the LED 52 to the fan control part 16.

For example, the fan control part 16 starts rotational driving of the blades 32 in the fan 3 when the temperature indicated by the temperature information is equal to or higher than a predetermined start threshold value, and stops rotational driving of the blades 32 in the fan 3 when the temperature indicated by the temperature information falls below a predetermined stop threshold value. Controlling the fan in this way can properly suppress increase in the temperature of the LED 52, and since the fan 3 is not driven to rotate when the temperature of the LED 52 is below the threshold value, can prevent generation of noise caused by rotation of the fan 3 or prevent consumption of power used for rotational driving of the fan 3.

The fan control part 16 may also change the rotation speed of the fan 3 stepwise or gradually according to the temperature of the LED 52. Controlling the fan in this way can properly suppress increase in the temperature of the LED 52 by increasing the rotation speed of the fan 3 according to an increase in the temperature of the LED 52 and decreasing the rotation speed of the fan 3 according to a decrease in the temperature of the LED 52, and at the same time, can suppress the noise caused by rotation of the fan 3 or suppress consumption of power required for rotational driving of the fan 3.

The fan control part 16 may also change the rotation direction of the blades 32 in the fan 3 at a predetermined timing. Specifically, for example, the fan control part 16 includes a counter which counts the number of starts of rotational driving of the fan 3, and when the count value of the counter has reached a predetermined value, resets the count value and rotates the blades 32 of the fan 3 in the direction opposite to a predetermined rotation direction for a predetermined time. Or, the fan control part 16 may include a timer which times out and is reset when the blades 32 of the fan 3 has rotated in a predetermined direction for a preset accumulated time, and may rotate the blades 32 in the direction opposite to the predetermined rotation direction for a predetermined time when the timer times out. Controlling the fan in this way can prevent dust from entering into the case 2 through the air intake port or the air discharge port of the illumination device. In addition, it is possible to remove the dust attached to the fan 3 from the fan 3 or soften the grease solidified on the rotating shaft of the blades 32.

The embodiments and the modified examples related to the illumination device having been described so far can be implemented in combination as far as possible.

### Reference Signs List

1 Illumination device
2 Case
3 Fan
4 Heat sink
5 LED module
6 Second heat sink
7 Lens
21 Open face
22 Case main body
23 Base part
41 Bottom part
42 Cylindrical wall part
43 Open end
44 Through-hole
51 LED substrate
52 LED
61 Division wall

1. An illumination device comprising:
a case having an open face on the front end side;
a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case;
a fan which is housed in the case so as to face the outer surface of the bottom part in the heat sink and serves to cool the LED;
an air intake passage which guides to the fan, air introduced from the lateral side of the case into the case; and
an air discharge passage which is formed along the outer surface of the bottom part and the outer wall surface of the cylindrical wall part in the heat sink and discharges the air sent from the fan from the front end side of the heat sink to the outside.

2. The illumination device according to claim 1, wherein a through-hole penetrating the bottom part is formed in the bottom part of the heat sink.

3. The illumination device according to claim 2, further comprising a lens which is fitted in the heat sink and has a lateral surface disposed so as to face the inner wall surface of the cylindrical wall part such that a ventilation path is formed between the lateral surface and the inner wall surface, wherein
part of the air sent from the fan toward the outer surface of the bottom part in the heat sink is discharged to the outside through the through-hole and the ventilation path.

4. The illumination device according to claim 1, wherein the inner wall surface of the cylindrical wall part is formed as a reflector which reflects the light generated by the LED.

5. The illumination device according to claim 1, further comprising a second heat sink provided between the case and the heat sink, wherein
the second heat sink has a cylindrical division wall which divides the inside of the case, such that a clearance is provided between the division wall and the cylindrical wall part as well as between the division wall and the inner wall surface of the case, while covering the cylindrical wall part of the heat sink, and a protruding edge part which is formed by the front open end side of the division wall protruding further to the front side than the open face of the case, and the rear open end of the division wall is disposed so as to face an air outlet of the fan,
outside air is introduced from the clearance created between the protruding edge part of the second heat sink and the front end edge part of the case, and the introduced air is guided to the fan through the clearance between the inner wall surface of the case and the outer wall surface of the division wall, and
the air from the fan is discharged to the outside through the clearance between the outer wall surface of the cylindrical wall part of the heat sink and the inner wall surface of the division wall.

6. The illumination device according to claim 5, wherein the heat sink further has:
a second protruding edge part which is formed by the open end side of the cylindrical wall part protruding further to the front side than the open face of the case, and is disposed so as to face the protruding edge part of the second heat sink; and
multiple protruding parts which protrude from the outer surface of the second protruding edge part so as to abut on the protruding edge part of the second heat sink, and leave part of the clearance between the protruding edge part of the second heat sink and the second protruding edge part as an air discharge port while covering the rest of the clearance.

7. The illumination device according to claim 6, wherein, of adjacent ones of the protruding parts, a pair of opposite wall surfaces which extends from the second protruding edge part of the heat sink toward the protruding edge part of the second heat sink and forms one of the air discharge ports is inclined in the same direction.

8. The illumination device according to claim 5, wherein the air outlet of the fan is coupled with the rear open end of the division wall in the second heat sink.

9. The illumination device according to claim 1, wherein an air intake port communicating with the air intake passage is formed at a position of the outer wall surface of the case on the rear side of the position where the air outlet of the fan housed in the case is disposed.

10. The illumination device according to claim 9, wherein the heat sink has:
a collar part which is formed on the open end side in the cylindrical wall part and protrudes further to the lateral side than the other portions; and
an air discharge port which penetrates the collar part.

11. The illumination device according to claim 10, wherein
the air discharge port is defined by a pair of wall surfaces along the radial direction of the collar part and a pair of wall surfaces along the circumferential direction of the collar part, and
the pair of wall surfaces along the radial direction of the collar part is inclined in the same direction.

12. An illumination device comprising:
a case having an open face on the front end side;
a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case;
a fan which is housed in the case so as to face the outer surface of the bottom part in the heat sink and serves to cool the LED;
a first ventilation path communicating between the outside of the case on the lateral side and the fan; and
a second ventilation path which is formed along the outer surface of the bottom part and the outer wall surface of the cylindrical wall part in the heat sink and communicates between the fan and the outside of the heat sink on the front end side, wherein
the fan is disposed between the first ventilation path and the second ventilation path.

13. The illumination device according to claim 12, wherein a power supply substrate is located on the rear end side of the illumination device so as to be cooled by air passing through the first ventilation path.

14. An illumination device comprising:
a case having an open face on the front end side;
a cylindrical closed-end heat sink which has a bottom part in which an LED module constituted of an LED mounted on a substrate is installed, a cylindrical wall part standing upright from the bottom part and disposed such that a clearance is created between the cylindrical wall part and an inner wall surface of the case, and an open end formed at the front end of the cylindrical wall part, and which is fitted in the case such that the open end is located on the open face side of the case;
a fan which is housed in the case so as to face the outer surface of the bottom part in the heat sink and serves to cool the LED;
an air intake passage which is formed along the outer wall surface of the cylindrical wall part and the outer surface of the bottom part in the heat sink and guides air introduced from the front end side of the heat sink to the fan; and
an air discharge passage which discharges the air sent from the fan from the lateral side of the case to the outside.
